(19) United States
(12) Patent Application Publication
(10) Pub. No.: US 2019/0086994 A1
(43) Pub. Date: Mar. 21, 2019

(54) TRANSITION OF AN INPUT / OUTPUT PORT IN A SUSPEND MODE FROM A HIGH-CURRENT MODE

(71) Applicant: Intel Corporation, Santa Clara, CA (US)

(72) Inventors: Rajaram Regupathy, Bangalore (IN); Abdul R. Ismail, Beaverton, OR (US)

(73) Assignee: Intel Corporation, Santa Clara, CA (US)

(21) Appl. No.: 15/709,111

(22) Filed: Sep. 19, 2017

(51) Int. Cl. G06F 1/32; G06F 13/38

(52) U.S. Cl. CPC G06F 1/3296; G06F 1/3253; G06F 13/382; G06F 1/3215

(57) ABSTRACT

An first apparatus is provided which comprises: a first port coupled to a second port of a second apparatus; first one or more circuitries to monitor current of a power bus that is to supply power from the first port to the second port; and second one or more circuitries to: while the first port is to operate in a high-current mode of operation, determine that the current of the power bus is less than a threshold current; and cause the first port to enter a suspend mode of operation from the high-current mode of operation, in response to the current of the power bus being less than the threshold current.

### BACKGROUND

Input/Output (I/O) ports, such as Universal Serial Bus (USB) ports, are being used in a plethora of computing devices. For example, USB type-C (USB-C) ports are now included in many modern electronic devices.

An I/O port, such as a USB-C port, may communicatively connect a USB host and a USB device. In addition to communication between the USB host and the USB device, the USB host may also supply power to the USB device (e.g., to charge a battery of the USB device, to supply power to operate the USB device, etc.). In some scenarios, e.g., as specified in the USB Power delivery (PD) Specification, the USB device may also supply power to the USB host. Thus, in some examples, the role of power source and power sink may be interchangeable between the USB host and the USB device.

It may be useful to develop solutions that facilitate seamless and efficient transition of I/O ports, such as USB-C ports, to a suspend or a low power state, e.g., to save power of the USB host and/or the USB device.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 schematically illustrates a system comprising a first device communicating with a second device via an I/O port, where the first device comprises port control circuitry to manage a low power mode (e.g., a suspend mode) of the I/O port, according to some embodiments.

FIG. 2 illustrates a configuration channel of a USB link, according to some embodiments.

FIG. 3 illustrates a flowchart depicting a method for entering a source port in a suspend mode from a high-current mode, based on monitoring a current supplied from the source port to a sink port, according to some embodiments.

FIG. 4 illustrates a flowchart depicting a method for entering a source port in a suspend mode from a high-current mode, based on monitoring a current supplied from the source port to a sink port of a sink device, where the sink device is a USB PD compliant device, according to some embodiments.

FIG. 5 illustrates a computer system, computing device or a SoC (System-on-Chip), where a source port may enter a suspend mode from a high-current mode, based on a current supplied from the source port to a sink port of a sink device being monitored, according to some embodiments.

### DETAILED DESCRIPTION

In an example, a USB power source device (also referred to as a source device) can operate in a default-current mode (e.g., where the source device can supply up to a default current to a USB sink device), or in a high-current mode (e.g., where the source device can supply up to a higher current to the USB sink device). Conventionally (e.g., as specified in the USB specification), if the source device is operating in the default-current mode, a source USB port of the source device can enter a USB suspend state. However, if the source device is operating in the high-current mode, the source USB port cannot enter the USB suspend state from the high-current mode of operation.

In another example, a source device, which may be a USB device, can supply power to a sink device, which may be a USB host (e.g., where the sink device can be a USB PD compliant device). Conventionally (e.g., as specified in the USB specification), once the source device enters in a power contrast with the sink device, the source USB port cannot enter in the suspend state (e.g., as the suspend state decision is usually taken by the USB host, and not by the USB device).

Various embodiments of this disclosure solve the above discussed issues. For example, in some embodiments, the source device may detect load of a Vbus supplying power from the source port to the sink port, e.g., to determine the current or power requirement of the sink device. When the source device detects that the sink current or power requirement has gone to a relatively low level (e.g., which may indicate trickle charging of a battery of the sink device) and if the USB bus is inactive for at least a threshold period of time, the source port and/or associated circuitries may to transition to the low power standby mode or suspend mode, as discussed in further details herein later. Other technical effects will be evident from the various embodiments and figures.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.” The terms “substantially,” “close,” “approximately,” “near,” and “about,” generally refer to being within +/- 10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,”, “bottom,” “over,” “under,” and the like in the description and in the claims, if any, are used for descriptive purposes and not necessarily for describing permanent relative positions.

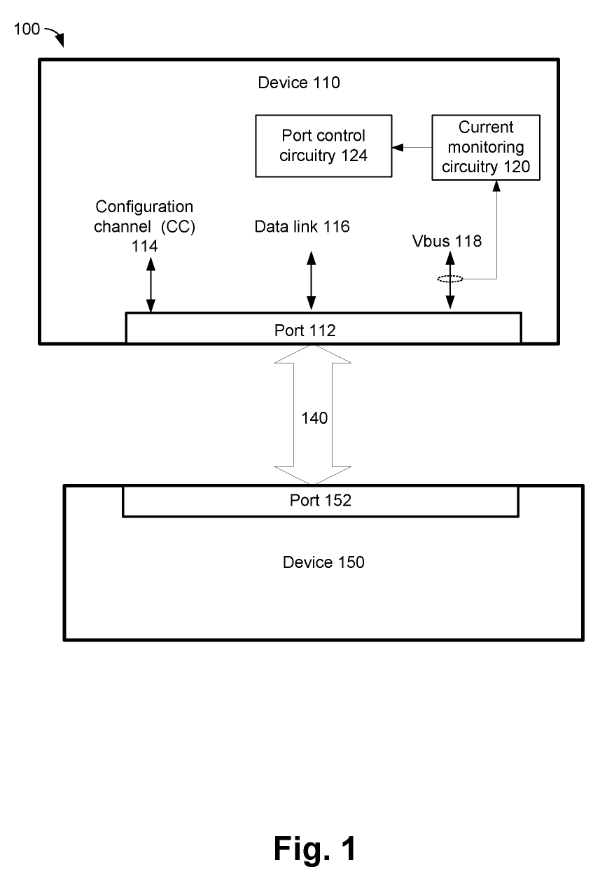

FIG. 1 schematically illustrates a system 100 comprising a first device 110 communicating with a second device 150 via an I/O port 112 (henceforth also referred to as port 112), where the first device 110 comprises port control circuitry 124 (henceforth also referred to as “circuitry 124”) to manage a low power mode (e.g., a suspend mode) of the I/O port 112, according to some embodiments.

In some embodiments, the port 112 may be a USB port, e.g., a USB-C port. In some embodiments, the port 112 may be any other appropriate type of port, e.g., a Thunderbolt port, an Ethernet Port, a legacy USB port, and/or the like. Various embodiments have been discussed herein under the assumption that the port 112 is a USB-C port—however, the principles of this disclosure may also be applied to any other appropriate type of I/O port as well.

In some embodiments, the port 112 of the device 110 may communicate with an I/O port 152 (henceforth also referred to as port 152) of the device 150. The port 152 may be any appropriate type of port, e.g., USB port (e.g., a USB-C port), a Thunderbolt port, an Ethernet Port, or the like. Various embodiments have been discussed herein under the assumption that the port 152 is a USB-C port—however, the principles of this disclosure may also be applied to any other appropriate type of I/O port as well.

In some embodiments, the ports 112 and 152 may be coupled via a link 140. The link 140, for example, may be a USB link coupling USB ports 112 and 152. For such an example, the link 140 may also be referred to as a USB link 140.

In some embodiments, the link 140 may comprise a configuration channel (CC) 114. For example, the ports 112 and 152 may communicate configuration parameters via the CC 114. In some embodiments, the link 140 may comprise a data link 116, which may be used to communicate data (e.g., USB data) between the ports 112 and 152.

In some embodiments, the device 110 may supply power to the device 150 and/or receive power from the device 150, e.g., over a Vbus 118. For example, the device 110 may act as a source and/or a sink for power transfer between the devices 110 and 150. The USB link 140 may comprise the Vbus 118.

In some embodiments, the device 110 may be a power source and the device 150 may be a power sink. As specified in the USB power Delivery (PD) specification, e.g., specification 3.0 or other versions thereof, a role of a power source and power sink may be interchangeable (e.g., if the devices 110 and 150 are USB PD compliant devices). However, in various embodiments discussed herein, the device 110 is assumed to undertake a role of a power source and the device 150 is assumed to undertake a role of a power sink. Accordingly, the device 110 is also referred to as a source device or a power source device, and the port 112 is also referred to as a source port; and the device 150 is also referred to as a sink device or a power sink device, and the port 152 is also referred to as a sink port.

In a first example, assume that the device 110 is a USB host such as a laptop; and the device 150 is a USB device such as a cellular phone. In such an example, the USB device 150 may be a non-power delivery or a non-PD USB device—the device 150 may receive power from the device 110 over the USB link 140, but the device 150 may not transmit power to the device 110. Thus, when the device 100 is connected to the device 150, the devices 110 and 150 may communicate over the USB data link 116. Additionally or alternatively, the device 150 may receive power from the device 110, e.g., using the Vbus 118 of the USB link 140. In this example, the device 110 acts as a power source and the device 150 acts as a power sink.

In a second example, assume that the device 110 is a USB PD device such as a display monitor, and the device 150 is a USB host such as a laptop. In such an example, the device 110 may receive alternating current (AC) power from a AC power outlet. If the device 150, which may be the laptop, is connected to the device 110 over the USB link 140, the device 150 may receive power from the device 110 over the USB link 140 (e.g., to charge a battery of the device 150, to operate the device 150. etc.). In this example, the device 110 acts as a power source and the device 150 acts as a power sink (although in some example, the role may be reversed).

Thus, as discussed herein above, in some embodiments, the device 150 may be a PD device or a non-PD device. For example, if the device 150 is a non-PD device, then the device 150 may act as a power sink only, and may not be a power source (e.g., may not act in accordance with the USB PD Specification). In another example, if the device 150 is a PD device, then the device 150 may act as a power sink and/or a power source (e.g., in accordance with the USB PD Specification).

For example, power delivery over USB ports has been defined through specification USB Type-C (USB-C) Cable and Connector Specification 1.2 and USB Power Deliver (PD) Specification 3.0. These specifications define devices which are Dual Role Power (DRP), e.g., which can act as either a power source or a power sink. Thus, for example, a PD device can act as a DRP device.

In some embodiments, the device 110 may comprise a current monitoring circuitry 120 (also referred to as circuitry 120) and a port control circuitry 124 (also referred to as circuitry 124). The circuitry 120 may monitor current in the Vbus 118 (symbolically illustrated as a dotted oval in FIG. 1). For example, various embodiments discussed herein is related to the device 110 being a power source and the device 150 being a power sink (although, as discussed herein, such roles may be interchangeable). In such scenarios, the circuitry 120 may monitor the current and/or the power supplied from the port 112 to the port 152 via the Vbus 118.

In some embodiments, the circuitry 124 may control the port 112. Merely as an example, the circuitry 124 may comprise a Device Policy Manager (DPM) associated with the port 112. The circuitry 124 may, among other things, monitor and control an operating state of the port 112, control a resistance value of a pull-up resistor Rp associated with the port 112, etc., as discussed in further detail herein later.

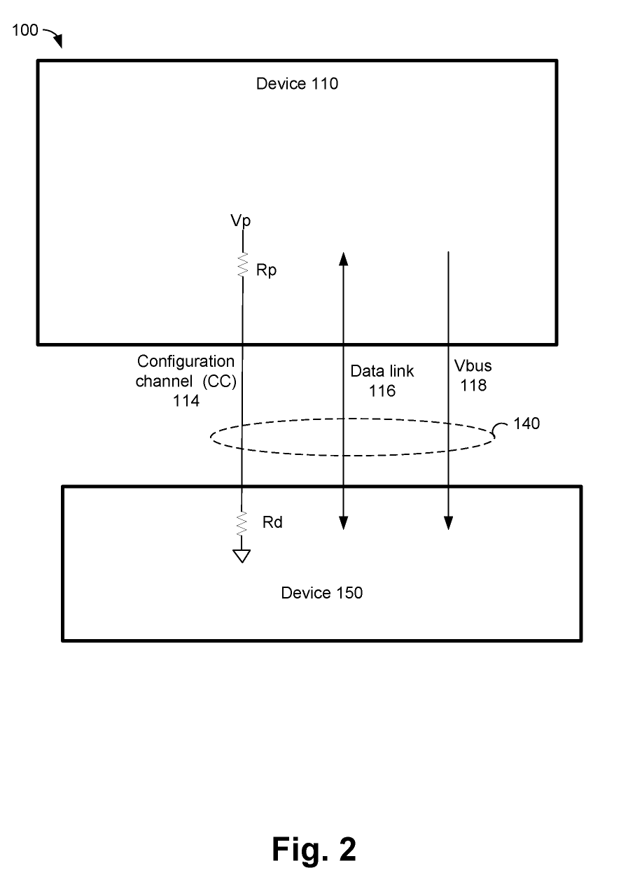

FIG. 2 illustrates the CC 114 of the USB link 140 of FIG. 1, according to some embodiments. The ports 112 and 152 are not illustrated in FIG. 2 for purposes of illustrative clarity—but the CC 114 may couple the two ports 112 and 152.

In some embodiments, the CC 114 may be coupled to a pull up resistor Rp in the device 110, and may be coupled to a pull down resistor Rd in the device 150. The CC 114 may be powered by a voltage Vp. In some embodiments, the device 110 (e.g., the circuitry 124) may vary the resistance value of the pull up resistor Rp, e.g., to indicate to the device 150 about an operating mode of the port 112.

The following Table 1 illustrates various operating modes of the port 112 and the corresponding values of the pull-up resistor Rp.

TABLE 1

| | Resistor pullup | Resistor Pullup to 3.3 V ± |
|---|---|---|
| Source Advertisement | to 4.75-5.5 V | 5% |
| 900 mA at 5 V (default- | 56k Ohms | 36k Ohms |
| current mode) | | |
| 1.5 A at 5 V (first high- | 22k Ohms | 12k Ohms |
| current mode) | | |
| 3 A at 5 V (second high- | 10k Ohms | 4.7k Ohms |
| current mode) | | |

The first column of Table 1 illustrates various operating modes of the port 112, e.g., as advertised by the pull-up resistor Rp. For example, during a default-current mode, the device 110 may supply up to 900 milliAmpere (mA) to the device 150; during a first high-current mode, the device 110 may supply up to 1.5 Amperes (A) to the device 150; and during a second high-current mode, the device 110 may supply up to 3 A to the device 150.

The second column of Table 1 illustrates example values of the pull-up resistor Rp, e.g., if the pull-up resistor Rp is sourced by a voltage of 4.75-5.5 V, corresponding to various operating modes. The third column of Table 1 illustrates example values of the pull-up resistor Rp, e.g., if the pull-up resistor Rp is sourced by a voltage of 3.3V±5%, corresponding to various operating modes.

The port 112 may set an appropriate value of the pull-up resistor Rp to indicate a mode of operation of the port. Merely as an example, a value of 12 killo Ohms (k Ohms) of the pull-up resistor Rp may indicate that the port 112 is to operate at the first high-current mode and is to supply up to 1.5 A at 5 V to the port 152 (e.g., if the pull-up resistor Rp is sourced by a voltage of 3.3V±5%).

Thus, the source device 110 may presents an appropriate value of the pull up resistance Rp on the CC 114, e.g., to advertise a current level that may be supported by the port 112. The sink device 150 may use a difference on the CC 114 to determine a maximum current that may be drawn from the source port 112. Put differently, the device 150 may sense the resistance value of the pull-up resistor Rp, and may be aware of a maximum current that may be supplied by the port 112 to the port 152. In an example, the sink port 152 may be aware of dynamic changes of Rp by the source port 112.

The entries in Table 1 above are merely examples. The entries may change in some examples, and the entries in the table does not limit the teachings of this disclosure. For example, instead of a first and second high-current mode and the default-current mode, there may be other modes (e.g., a third high-current mode) of the port 112. Similarly, the current values and/or the pull up resistance values may also change based on the implementation. default-current mode

In an example, the default-current mode of Table 1 may also be referred to as a default USB power level, a default-power mode, and/or the like. In an example, a high-current mode of Table 1 may also be referred to as a high USB power level, a high-power mode, and/or the like.

For purposes of this disclosure and unless otherwise specified, a reference to a high-current mode may refer to one of the first or second high-current modes of Table 1.

In some embodiments, for higher power requirements, the system 100 may use the USB PD protocol to negotiate a power of, for example, greater than 15 W and up to 100 W. For example, using the USB PD protocol, the devices 110 and 150 may negotiate a power that may be supplied by the device 110 to the device 150.

In some embodiments, a USB Suspend is a low power state defined by the USB specifications as part of USB ecosystem power management. The USB suspend may also be referred to as a low power mode, a sleep mode, a suspend mode, USB suspend mode, USB suspend state, and/or the like. A port (e.g., the port 112) may enter the USB suspend state, e.g., when there is no bus activity (e.g., activity in the data link 116) for, for example, at least 3 millisecond (ms). In an example, when a port 112 enters the suspend mode, the port 112 may consume relatively low amount of current (e.g., about 2.5 mA).

In an example, the USB specification dictates that the USB suspend power rules may apply when the USB Type-C current is at the default USB power level. Thus, conventionally, the port 112 may enter the suspend mode if the port 112 is at the default-current mode of Table 1. Thus, conventionally, if the port 112 is set at any of the first or second high-current mode, the port 152 may be allowed to continue to drawing the high-current via the Vbus 118. For example, conventionally, if the port 112 is set at a high-current mode, the port 112 cannot enter the suspend state and have a low current consumption of 2.5 mA. Moreover, the USB specification does not dictate a port (e.g., the port 112) downgrading from a high-current mode to the default-current mode.

In USB PD environment, a source port (e.g., the port 112) may have to indicate a sink port (e.g., port 152) of USB Suspend requirement in a Source Capability message transmitted by the source to the sink. For example, if a USB Suspend Supported flag is set, then the sink port may have to follow the USB suspend. If the USB Suspend Supported flag is cleared, then the sink port need not apply the USB suspend rule and may continue to draw the negotiated power. In an example, a sink port (e.g., based on its power requirements) may also inform the source port that it would need higher power, and the sink port may override the suspend rule.

Assume a first example scenario in which the device 150 is a battery powered device operating in 5V, 2A level (e.g., a mobile phone). The device 150 in the first scenario may be a non-PD USB device. In an example, battery operated device like mobile phones may operate in 5V range, and may not implement USB PD. For example, the device 150 may rely on the pull-up resistor Rp current advertisement of the source device 110 for higher power. In an example, when the device 150 is connected to a laptop (e.g., which may be the device 110), the port control circuitry 124 (e.g., a DPM of the device 110) of the device 110 may present the pull-up resistor Rp corresponding to a high-current mode (e.g., the second high-current mode corresponding to 3A). This may result in higher current being supplied to the device 150, e.g., to enable relatively faster charging the battery of the device 150. Initially the battery of the device 150 may need higher power for charging. After the battery of the device 150 is charged beyond a threshold level (e.g., about 100% charged), the battery of the device 150 may enter a trickle charging mode (e.g., may receive a small amount of current to continue being the charge at about the full 100% level). However, conventionally (e.g., relying on the USB specification), the port 112 may not enter the suspend mode or change the pull-up resistor Rp to the default-current mode even when the battery is being trickle charged, e.g., as the port 112 is operating at the high-current mode. This may result in the port 112 wasting power and preventing any possible re-allocation of power from the port 112 to other USB ports of the device 110.

Assume a second scenario in which the device 150 is a 20 V, 1.5 A rated battery operated device, such as a laptop, and the device 110 is a monitor (e.g., a USB-C/USB PD enabled USB Display unit). The device 150 may receive power from the device 110. In the second scenario, the USB display device 110 may act as a power source to the laptop device 150. In this scenario, though the laptop device 150 may be a USB host and the USB display device 110 may be a USB Device, the power may flow from the USB device 110 to the USB host 150. In an example, the USB may be a Host centric ecosystem, e.g., where in which most or every activity may be managed by the USB host (e.g., including managing the bus power management). Thus, a problem may arise, because a power source (e.g., the USB display device 110) cannot indicate a power sink (e.g., the USB host device 150) to enter the low power USB Suspend mode. Conventionally, this situation may limit the USB display device 110 to enter the standby or power conservation mode, as the USB display device 110 may not conventionally be able to relinquish the power and establish a new contract with the device 150.

Thus, the above discussed example first and/or second scenarios may make it difficult to enter the suspend, low power, or standby mode by the port 112 of the power source device 110. Put differently, in a USB-C environment (e.g., where the device 150 is a non-PD device), the circuitry 124 of the source device 110 may lack knowledge to put a sink to low power USB suspend mode; and in a USB PD environment (e.g., where the device 150 is a PD device), a USB host sink DPM (e.g., the device 150) may lack definition and knowledge to indicate to put the port 112 of the power source device 110 to the USB suspend mode. This gap may limit the ability of the system 100 to conserve power and effectively enter the suspend mode, thereby possibly leading to resource wastage.

As discussed herein later in further details, some of the embodiments proposes to improve the decision-making capability of the port control circuitry 124 of the device 110 to enter a low power state or a suspend state, e.g., by providing feedback on the current consumption in the Vbus 118 and/or battery information retrieved from the sink device 150. This may enable the circuitry 124 to take decision to change the pull-up resistor Rp value corresponding to the default-current mode, e.g., thereby enabling the port 112 to enter the low power USB suspend (e.g., if the device 150 is a non-PD USB-C device). Similarly, in the USB PD ecosystem, the feedback information along with USB bus activity may enable the port 112 to enter the low power standby or suspend mode to conserve power.

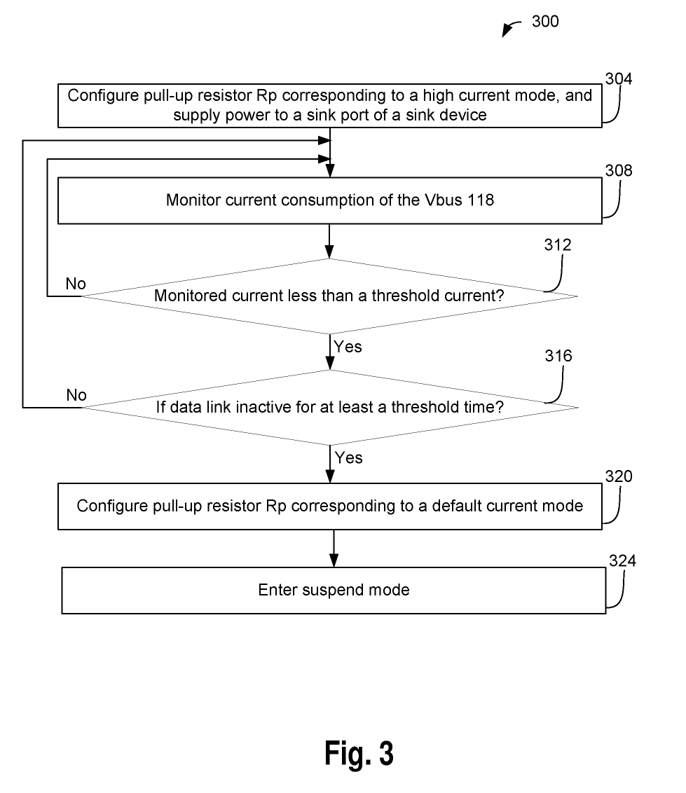

FIG. 3 illustrates a flowchart depicting a method 300 for entering a source port (e.g., port 112) in a suspend mode from a high-current mode, based on monitoring a current supplied from the source port to a sink port (e.g., port 152), according to some embodiments. Although the blocks in the flowchart with reference to FIG. 3 are shown in a particular order, the order of the actions can be modified. Thus, the illustrated embodiments can be performed in a different order, and some actions/blocks may be performed in parallel. Some of the blocks and/or operations listed in FIG. 3 may be optional in accordance with certain embodiments. The numbering of the blocks presented is for the sake of clarity and is not intended to prescribe an order of operations in which the various blocks must occur.

In an example, the method 300 may be applicable when the device 110 is a host device acting as a power source, and when the device 150 is a USB device acting as a power sink. In an example, the method 300 may be applicable when the device 150 is a non-PD device. A non-PD device may be, for example, a USB-C device without USB Power Delivery (PD) capability. For example, the USB-C port of the non-PD device may supply 5V (e.g., only 5 V) when it presents Rp. On the other hand, a USB-C PD device (also referred to as USB-C PD capable device) may negotiate a higher voltage (e.g., higher than 5V) using Power Delivery protocol. For example, the device 150 may be a USB-C device that may act as a power sink, but may not necessarily act as a power source for the method 300. Accordingly, in some embodiments and for purposes of the method 300, the device 150 may operate in accordance with the USB-C specification, but may not necessarily operate in accordance with the USB PD specification.

At 304, the pull-up resistor Rp of the device 110 may be configured to correspond to a high-current mode. For example, the circuitry 124 may configure the pull-up resistor Rp to correspond to a resistance value of one of the first high-current mode or the second high-current mode, e.g., as discussed herein with respect to Table 1. Also at 304, the source port 112 may supply current to the port 152 of the device 150 via the Vbus 118. In an example, a maximum current supplied may be in accordance with the high current mode corresponding to the configured pull-up resistor Rp. Thus, the port 112 may operate in the high current mode of operation. Merely as an example, the device 152 may use the received current to charge a battery (not illustrated in the figures) of the device 150, to operate the device 150, etc.

At 308, the current consumption of the Vbus 118 may be monitored, e.g., by the current monitoring circuitry 120. Such monitoring may be continuous, at periodic or aperiodic intervals (e.g., intermittently), and/or the like. Any appropriate current monitoring or current measurement technique may be used for such monitoring the current of the Vbus 118.

At 312, it may be determined if the monitored current is less than a threshold current. In some embodiments, the threshold current may be the current of the default-current mode. As an example, the current of the default-current mode, as discussed with respect to Table 1, is 900 mA, and the threshold may be equal to 900 mA. In some embodiments, the threshold may be less than the current of the default-current mode. The threshold may be, merely as an example, 80%, 75%, 50%, or another appropriate percentage of the current of the default-current mode. In some embodiments, a current of the port 112 during a USB suspend mode may be about 2.5 mA, and hence, the threshold may be about 2.5 mA or slightly higher (or lower) than 2.5 mA. In some embodiments, the threshold current may be a current that indicates a trickle charging of a battery of the device 150.

In some embodiments, the decision at 312 may be to check whether the device 150 is in a trickle charging mode. For example, at 304, the port 112 may start operating at the high current mode and supply, for example, up to 1.5 A or 3 A of current to the device 150, e.g., to charge the battery of the device 150. Once the battery of the device 150 is substantially or fully charged, the port 152 may start drawing less amount of current from the port 112. For example, the port 152 may start drawing just enough current from the port 112 for trickle charging the battery (e.g., to make sure that the battery charge level is maintained substantially at the full charge level). The trickle charging current drawn from the port 112 may be a few milli-Amperes, e.g., less than the threshold of 312. Thus, the decision box at 312, in some examples, may effectively check if the port 112 is merely supplying very less current for trickle charging the battery of the device 150. The decision at 312 may be performed by the circuitry 120 and/or the circuitry 124.

If “No” at 312, the method 300 may loop back to 308, where the circuitry 120 may continue to monitor the current of the Vbus 118.

If “Yes” at 312, the method 300 may proceed to 316, where it may be determined if the USB bus (e.g., the data link 116) is inactive for at least a threshold period of time. For example, the threshold period of time may be about 3 ms, although another appropriate value of the threshold period of time may be possible. The determination at 316 may be performed by the circuitry 124.

If “No” at 316, the method 300 may loop back to 308, where the circuitry 120 may continue to monitor the current of the Vbus 118.

If “Yes” at 316, then this may indicate that the current drawn via the Vbus 118 of the port 118 is relatively less (e.g., may correspond to trickle charging of the battery of the device 150), and there is no data communication via the USB link 140 between the ports 112 and 152 for at least the threshold period of time.

Accordingly, if “Yes” at 316, the method 300 may proceed to 320, where the pull-up resistor Rp may be configured corresponding to the default-current mode, e.g., as discussed with respect to Table 1. For example, the resistance of the pull-up resistor Rp may be changed to one of 56k Ohms or 36k Ohms, as indicated in the Table 1. This may transition the port 112 from the high-current mode to the default-current mode.

At 324, the USB system of the device 110 (e.g., the port 112, the circuitries 124 and/or 120, and/or other components associated with the port 112) may enter the suspend mode. For example, the USB system of the device 110 may enter the suspend mode from the default-current mode.

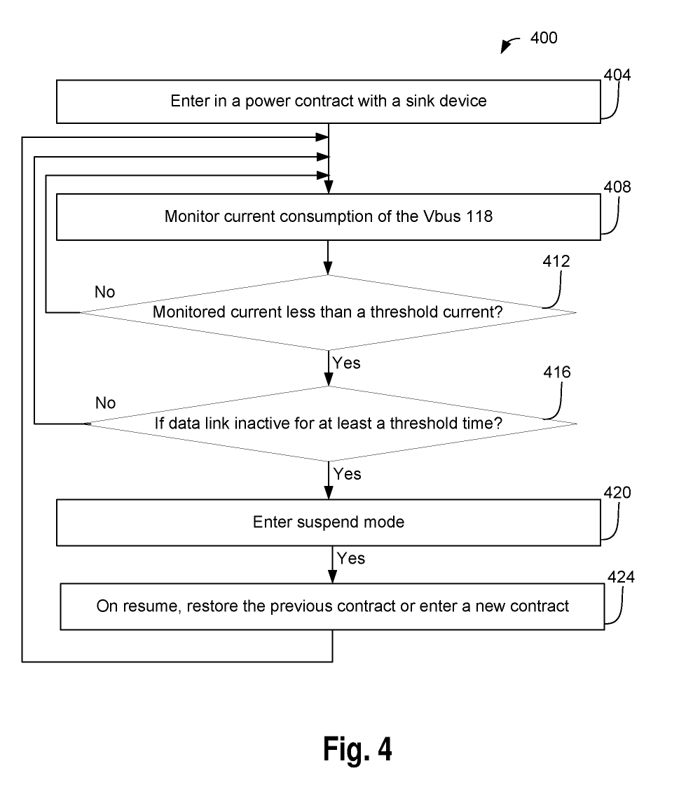

FIG. 4 illustrates a flowchart depicting a method 400 for entering a source port (e.g., port 112) in a suspend mode from a high-current mode, based on monitoring a current supplied from the source port to a sink port (e.g., port 152) of a sink device (e.g., device 150), where the sink device is a USB PD compliant device, according to some embodiments. Although the blocks in the flowchart with reference to FIG. 4 are shown in a particular order, the order of the actions can be modified. Thus, the illustrated embodiments can be performed in a different order, and some actions/blocks may be performed in parallel. Some of the blocks and/or operations listed in FIG. 4 may be optional in accordance with certain embodiments. The numbering of the blocks presented is for the sake of clarity and is not intended to prescribe an order of operations in which the various blocks must occur.

In some embodiments, the method 400 may be applicable when the device 110 is acting as a power source, and when the device 150 is acting as a power sink. In some embodiments, the method 400 may be applicable when the device 150 is a PD compliant devices. Thus, in an example, the device 150 may act as a power source, and may also act a power sink. In some embodiments, the method 400 may be applicable when the device 150 is a USB host and the device 110 is a USB device. Accordingly, in some embodiments, the device 150 may operate in accordance with the USB-C specification and the USB PD specification. Merely as an example, the device 150 may be a laptop, and the device 110 may be a monitor or display that can supply power to the laptop.

At 404, a power contract may be negotiated between the devices 110 and 150, e.g., to supply power via the Vbus 118 from the port 112 to the port 152. For example, the circuitry 124 (which may comprise, for example, a DPM associated with the port 112) may enter in a power contract with the device 150. The power contract may be to supply power to the port 152 via the Vbus 118.

At 408, the current consumption of the Vbus 118 may be monitored, e.g., by the current monitoring circuitry 120. Such monitoring may be continuous, at periodic or aperiodic intervals (e.g., intermittently), and/or the like. Any appropriate current monitoring or current measurement technique may be used for such monitoring the current of the Vbus 118.

At 412, it may be determined if the monitored current is less than a threshold current. In some embodiments, the threshold current may be the current of the default-current mode, e.g., less than 900 mA. In some embodiments, the threshold current may be the current of the contract entered at 404 (or a fraction of the current of the contract entered at 404). In some embodiments, the threshold current may be a current that indicates a trickle charging of a battery of the device 150. In some embodiments, a current at the Vbus 118 during a USB suspend mode may be about 2.5 mA, and hence, the threshold current may be about 2.5 mA or slightly higher (or lower) than 2.5 mA.

In some embodiments, the decision at 412 may be to check whether the device 150 is in a trickle charging mode, e.g., as discussed with respect to the operations at 312 of FIG. 3. The decision at 412 may be performed by the circuitry 120 and/or the circuitry 124.

If “No” at 412, the method 400 may loop back to 408, where the circuitry 120 may continue to monitor the current of the Vbus 118.

If “Yes” at 412, the method 400 may proceed to 416, where it may be determined if the USB bus (e.g., the data link 116) is inactive for at least a threshold period of time. For example, the threshold period of time may be about 3 ms, although another appropriate value of the threshold period of time may be possible. The determination at 416 may be performed by the circuitry 124.

If “No” at 416, the method 400 may loop back to 408, where the circuitry 120 may continue to monitor the current of the Vbus 118.

If “Yes” at 416, then this may indicate that the current drawn via the Vbus 118 of the port 118 is relatively less (e.g., may correspond to trickle charging of the battery of the device 150), and there is no data communication via the USB link 140 between the ports 112 and 152 for at least the threshold period of time. Accordingly, if “Yes” at 416, the method 400 may proceed to 420. At 420, the port 112 and associated circuitries (e.g., circuitries 120, 124, etc.) may enter the USB suspend mode. Optionally and although not illustrated in FIG. 4, at 420, the port 112 may come out of the power contract entered at 404.

At 424, the port 112 may come out of the suspend mode (e.g., based on a request from the port 152, activity on the data link 116, request for new power contract from the device 150, etc.), and may restore the previous power contract of 404 or may enter in a new power contract. Subsequently, the method 400 may loop back to the operations at 408.

Thus, in FIGS. 3-4, the source device 110 may detect load of the Vbus 118, e.g., to determine the current or power requirement of the sink device 150. When the source device 110 detects that the sink current or power requirement has gone to a relatively low level (e.g., which may indicate trickle charging of the battery of the device 150) and if the USB bus (e.g., the data link 116) is inactive for at least a threshold period of time, the circuitry 124 may cause the port 112 and/or associated circuitries to transition to the low power standby mode or suspend mode. In contrast, in a conventional USB system, a port can enter the suspend state if the port is in the default-current mode. That is, in a conventional USB system, a port cannot enter the suspend state from a high current mode or from a power contract that supplies relatively high current to the sink device. Also, in in a conventional USB system, a port of a USB device cannot enter the suspend state, if the port is in a power contract with a USB host device.

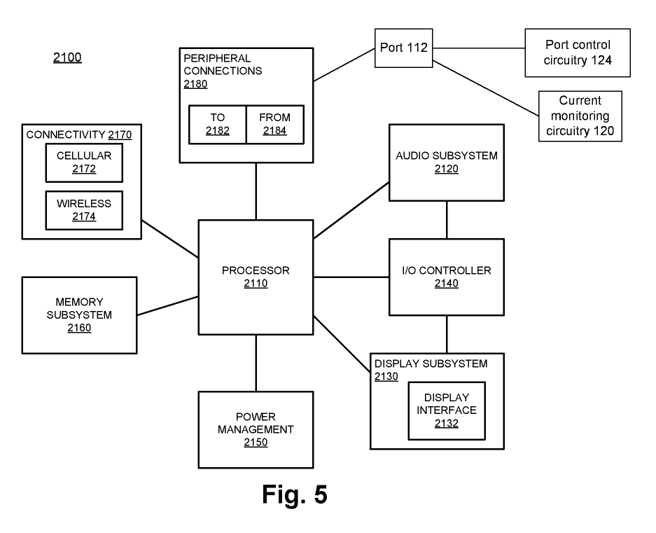

FIG. 5 illustrates a computer system, computing device or a SoC (System-on-Chip) 2100, where a source port (e.g., port 112) may enter a suspend mode from a high-current mode, based on a current supplied from the source port to a sink port (e.g., port 152) of a sink device (e.g., device 150) being monitored, according to some embodiments. It is pointed out that those elements of FIG. 5 having the same reference numbers (or names) as the elements of any other figure can operate or function in any manner similar to that described, but are not limited to such.

In some embodiments, computing device 2100 represents an appropriate computing device, such as a computing tablet, a server, a workstation, a mobile phone or smart-phone, a laptop, a desktop, an TOT device, a wireless-enabled e-reader, or the like. It will be understood that certain components are shown generally, and not all components of such a device are shown in computing device 2100.

In some embodiments, computing device 2100 includes a first processor 2110. The various embodiments of the present disclosure may also comprise a network interface within 2170 such as a wireless interface so that a system embodiment may be incorporated into a wireless device, for example, cell phone or personal digital assistant. The processor 2110 may be a SoC or a computing unit.

In one embodiment, processor 2110 can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display M.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100. In one embodiment, computing device 2100 includes a clock generation subsystem 2152 to generate a clock signal.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, the computing device 2100 may correspond to the device 110 of FIG. 1 (or the device 150 of FIG. 1). For example, the computing device 2100 may comprise the port 112, the circuitry 124, the circuitry 120, etc. In some embodiments, the port 112 may enter a suspend mode, based on a current supplied from the source port (e.g., port 112) of a source device (e.g., device 110) to a sink port (e.g., port 152) of a sink device (e.g., device 150) being monitored, as discussed with respect to FIGS. 1-4.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following example clauses pertain to further embodiments. Specifics in the example clauses may be used anywhere in one or more embodiments. All optional features of the apparatus described herein may also be implemented with respect to a method or process.

### EXAMPLE 1

A first apparatus comprising: a first port coupled to a second port of a second apparatus; first one or more circuitries to monitor current of a power bus that is to supply power from the first port to the second port; and second one or more circuitries to: determine that the current of the power bus is less than a threshold current, while the first port is to operate in a high-current mode of operation, and cause the first port to enter a suspend mode of operation from the high-current mode of operation, in response to the current of the power bus being less than the threshold current.

### EXAMPLE 2

The first apparatus of example 1 or any other example, further comprising: a pull-up resistor coupled to a configuration channel, the configuration channel coupled between the first port and the second port, wherein the pull-up resistor is to have a first resistance value while the first port is to operate in the high-current mode of operation, and wherein the pull-up resistor is to have a second resistance value while the first port is to operate in a default-current mode of operation.

### EXAMPLE 3

The first apparatus of example 2 or any other example, wherein to cause the first port to enter the suspend mode of operation from the high-current mode of operation, the second one or more circuitries are to: cause to change a resistance value of the pull-up resistor from the first resistance value to the second resistance value, in response to the current of the power bus being less than the threshold current, thereby causing the first port to transition from the high-current mode of operation to the default-current mode of operation; and cause the first port to enter the suspend mode of operation, subsequent to causing to change the resistance value.

### EXAMPLE 4

The first apparatus of example 2 or any other example, wherein: the current of the power bus during the default-current mode of operation is limited by 900 milli-Amperes; and the current of the power bus during the high-current mode of operation is limited by one of 1.5 Amperes or 3 Amperes.

### EXAMPLE 5

The first apparatus of example 2 or any other example, wherein: the threshold current is less than or equal to the current of the power bus during the default-current mode of operation.

### EXAMPLE 6

The first apparatus of example 2 or any other example, wherein the second port is a Universal Serial Bus type-C non-Power Delivery port (USB-C non-PD port).

### EXAMPLE 7

The first apparatus of any of examples 1-6 or any other example, wherein: the first port is a first Universal Serial Bus type-C (USB-C) port; and the second port is a second USB-C port.

### EXAMPLE 8

The first apparatus of any of examples 1-6 or any other example, wherein to cause the first port to enter the suspend mode of operation from the high-current mode of operation, the second one or more circuitries are to: determine lack of communication in a data link between the first port and the second port for at least a threshold time period; and cause the first port to enter the suspend mode of operation from the high-current mode of operation, in response to: the current of the power bus being less than the threshold current, and the lack of communication in the data link between the first port and the second port for at least the threshold time period.

### EXAMPLE 9

The first apparatus of any of examples 1-6 or any other example, wherein the second one or more circuitries comprises a Device Policy Manager (DPM) of the first port.

### EXAMPLE 10

A system comprising: a memory to store instructions; a processor coupled to the memory; a first Universal Serial Bus (USB) port that is to be coupled to a second USB port of another system, wherein the first USB port is to communicate data between the processor and the second USB port; and one or more circuitries to: enter in a contract to supply power from the first USB port to the second USB port over a power bus; determine that a current being supplied over the power bus corresponds to a trickle charging of a battery of the another system; and cause the first USB port to enter a USB suspend mode.

### EXAMPLE 11

The system of example 10 or any other example, wherein to determine that the current being supplied over the power bus corresponds to the trickle charging of the battery of the another system, the one or more circuitries are to: monitor the current being supplied over the power bus; and determine that the current being supplied over the power bus is less than a threshold value.

### EXAMPLE 12

The system of example 10 or any other example, wherein to cause the first USB port to enter the USB suspend mode, the one or more circuitries are to: determine lack of communication in a data link between the first USB port and the second USB port for at least a threshold time period; and cause the first USB port to enter the USB suspend mode, in response to: the current being supplied over the power bus corresponding to the trickle charging of the battery, and the lack of communication in the data link between the first USB port and the second USB port for at least the threshold time period.

### EXAMPLE 13

The system of example 10 or any other example, wherein the one or more circuitries are to: restore the contract to supply power from the first USB port to the second USB port, in response to the first USB port exiting the USB suspend mode.

### EXAMPLE 14

The system of any of examples 10-13 or any other example, wherein: the first USB port is a first USB type-C Power Delivery port (USB-C PD port); and the second USB port is a second USB-C PD port.

### EXAMPLE 15

The system of any of examples 10-13 or any other example, wherein: the system is to act as a USB device; and the another system is to act as a USB host.

### EXAMPLE 16

The system of any of examples 10-13 or any other example, wherein the one or more circuitries comprises a Device Policy Manager (DPM) of the first USB port.

### EXAMPLE 17

Non-transitory computer-readable storage media to store instructions that, when executed by a processor, cause the processor to perform operations comprising: operate a first port at a high-current mode of operation; monitor current of a power bus that is to supply power from the first port to a second port; monitor communication over a data link between the first port and the second port; and cause the first port to enter a suspend mode of operation from the high-current mode of operation, in response to: the current of the power bus being less than a threshold current and a lack of communication over the data link for at least a threshold period of time.

### EXAMPLE 18

The non-transitory computer-readable storage media of example 17 or any other example, wherein to cause the first port to enter the suspend mode of operation from the high-current mode of operation, the processor is to perform operations comprising: cause the first port to enter a default-current mode of operation from the high-current mode of operation; and cause the first port to enter the suspend mode of operation from the default-current mode of operation.

### EXAMPLE 19

The non-transitory computer-readable storage media of example 18 or any other example, wherein: the current of the power bus during the default-current mode of operation is limited by 900 milli-Amperes; and the current of the power bus during the high-current mode of operation is limited by one of 1.5 Amperes or 3 Amperes.

### EXAMPLE 20

The non-transitory computer-readable storage media of any of examples 17-19 or any other example, wherein: the first port is a first Universal Serial Bus type-C (USB-C) port; and the second port is a second USB-C port.

### EXAMPLE 21

A method comprising: operating a first port at a high-current mode of operation; monitoring current of a power bus that is to supply power from the first port to a second port; monitoring communication over a data link between the first port and the second port; and causing the first port to enter a suspend mode of operation from the high-current mode of operation, in response to: the current of the power bus being less than a threshold current and a lack of communication over the data link for at least a threshold period of time.

### EXAMPLE 22

The method of example 21 or any other example, wherein causing the first port to enter the suspend mode of operation from the high-current mode of operation comprises: causing the first port to enter a default-current mode of operation from the high-current mode of operation; and causing the first port to enter the suspend mode of operation from the default-current mode of operation.

### EXAMPLE 23

The method of example 21 or any other example, wherein: the current of the power bus during the default-current mode of operation is limited by 900 milli-Amperes; and the current of the power bus during the high-current mode of operation is limited by one of 1.5 Amperes or 3 Amperes.

### EXAMPLE 24

The method of any of examples 21-23 or any other example, wherein: the first port is a first Universal Serial Bus type-C (USB-C) port; and the second port is a second USB-C port.

### EXAMPLE 25

An apparatus comprising: means for performing the method of any of the examples 21-24 or any other example.

### EXAMPLE 26

One or more non-transitory computer-readable storage media to store instructions that, when executed by a processor, cause the processor to execute a method of any of the examples 21-24 or any other example.

### EXAMPLE 27

An apparatus comprising: means for operating a first port at a high-current mode of operation; means for monitoring current of a power bus that is to supply power from the first port to a second port; means for monitoring communication over a data link between the first port and the second port; and means for causing the first port to enter a suspend mode of operation from the high-current mode of operation, in response to: the current of the power bus being less than a threshold current and a lack of communication over the data link for at least a threshold period of time.

### EXAMPLE 28

The apparatus of example 27 or any other example, wherein the means for causing the first port to enter the suspend mode of operation from the high-current mode of operation comprises: means for causing the first port to enter a default-current mode of operation from the high-current mode of operation; and means for causing the first port to enter the suspend mode of operation from the default-current mode of operation.

### EXAMPLE 29

The apparatus of example 27 or any other example, wherein: the current of the power bus during the default-current mode of operation is limited by 900 milli-Amperes; and the current of the power bus during the high-current mode of operation is limited by one of 1.5 Amperes or 3 Amperes.

### EXAMPLE 30

The apparatus of any of examples 27-29 or any other example, wherein: the first port is a first Universal Serial Bus type-C (USB-C) port; and the second port is a second USB-C port.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. A first apparatus comprising:
a first port coupled to a second port of a second apparatus;
first one or more circuitries to monitor current of a power bus that is to supply power from the first port to the second port; and
second one or more circuitries to:
determine that the current of the power bus is less than a threshold current, while the first port is to operate in a high-current mode of operation, and
cause the first port to enter a suspend mode of operation from the high-current mode of operation, in response to the current of the power bus being less than the threshold current.

2. The first apparatus of claim 1, further comprising:
a pull-up resistor coupled to a configuration channel, the configuration channel coupled between the first port and the second port,
wherein the pull-up resistor is to have a first resistance value while the first port is to operate in the high-current mode of operation, and
wherein the pull-up resistor is to have a second resistance value while the first port is to operate in a default-current mode of operation.

3. The first apparatus of claim 2, wherein to cause the first port to enter the suspend mode of operation from the high-current mode of operation, the second one or more circuitries are to:
cause to change a resistance value of the pull-up resistor from the first resistance value to the second resistance value, in response to the current of the power bus being less than the threshold current, thereby causing the first port to transition from the high-current mode of operation to the default-current mode of operation; and
cause the first port to enter the suspend mode of operation, subsequent to causing to change the resistance value.

4. The first apparatus of claim 2, wherein:
the current of the power bus during the default-current mode of operation is limited by 900 milli-Amperes; and
the current of the power bus during the high-current mode of operation is limited by one of 1.5 Amperes or 3 Amperes.

5. The first apparatus of claim 2, wherein:
the threshold current is less than or equal to the current of the power bus during the default-current mode of operation.

6. The first apparatus of claim 2, wherein the second port is a Universal Serial Bus type-C non-Power Delivery port (USB-C non-PD port).

7. The first apparatus of claim 1, wherein:
the first port is a first Universal Serial Bus type-C (USB-C) port; and
the second port is a second USB-C port.

8. The first apparatus of claim 1, wherein to cause the first port to enter the suspend mode of operation from the high-current mode of operation, the second one or more circuitries are to:
determine lack of communication in a data link between the first port and the second port for at least a threshold time period; and
cause the first port to enter the suspend mode of operation from the high-current mode of operation, in response to: the current of the power bus being less than the threshold current, and the lack of communication in the data link between the first port and the second port for at least the threshold time period.

9. The first apparatus of claim 1, wherein the second one or more circuitries comprises a Device Policy Manager (DPM) of the first port.

10. A system comprising:
a memory to store instructions;
a processor coupled to the memory;
a first Universal Serial Bus (USB) port that is to be coupled to a second USB port of another system, wherein the first USB port is to communicate data between the processor and the second USB port; and
one or more circuitries to:
enter in a contract to supply power from the first USB port to the second USB port over a power bus;
determine that a current being supplied over the power bus corresponds to a trickle charging of a battery of the another system; and
cause the first USB port to enter a USB suspend mode.

11. The system of claim 10, wherein to determine that the current being supplied over the power bus corresponds to the trickle charging of the battery of the another system, the one or more circuitries are to:
monitor the current being supplied over the power bus; and
determine that the current being supplied over the power bus is less than a threshold value.

12. The system of claim 10, wherein to cause the first USB port to enter the USB suspend mode, the one or more circuitries are to:
determine lack of communication in a data link between the first USB port and the second USB port for at least a threshold time period; and
cause the first USB port to enter the USB suspend mode, in response to:
the current being supplied over the power bus corresponding to the trickle charging of the battery, and
the lack of communication in the data link between the first USB port and the second USB port for at least the threshold time period.

13. The system of claim 10, wherein the one or more circuitries are to:
restore the contract to supply power from the first USB port to the second USB port, in response to the first USB port exiting the USB suspend mode.

14. The system of claim 10, wherein:
the first USB port is a first USB type-C Power Delivery port (USB-C PD port); and
the second USB port is a second USB-C PD port.

15. The system of claim 10, wherein:
the system is to act as a USB device; and
the another system is to act as a USB host.

16. The system of claim 10, wherein the one or more circuitries comprises a Device Policy Manager (DPM) of the first USB port.

17. Non-transitory computer-readable storage media to store instructions that, when executed by a processor, cause the processor to perform operations comprising:
operate a first port at a high-current mode of operation;
monitor current of a power bus that is to supply power from the first port to a second port;
monitor communication over a data link between the first port and the second port; and
cause the first port to enter a suspend mode of operation from the high-current mode of operation, in response to: the current of the power bus being less than a threshold current and a lack of communication over the data link for at least a threshold period of time.

18. The non-transitory computer-readable storage media of claim 17, wherein to cause the first port to enter the suspend mode of operation from the high-current mode of operation, the processor is to perform operations comprising:
cause the first port to enter a default-current mode of operation from the high-current mode of operation; and
cause the first port to enter the suspend mode of operation from the default-current mode of operation.

19. The non-transitory computer-readable storage media of claim 18, wherein:
the current of the power bus during the default-current mode of operation is limited by 900 milli-Amperes; and
the current of the power bus during the high-current mode of operation is limited by one of 1.5 Amperes or 3 Amperes.

20. The non-transitory computer-readable storage media of claim 17, wherein:
the first port is a first Universal Serial Bus type-C (USB-C) port; and
the second port is a second USB-C port.
